(19) United States
(12) Patent Application Publication
(10) Pub. No.: US 2024/0031926 A1
(43) Pub. Date: Jan. 25, 2024

(54) NETWORK SLICE SUBNET INSTANCE CONFIGURATION

(71) Applicant: BRITISH TELECOMMUNICATIONS PUBLIC LIMITED COMPANY, London (GB)

(72) Inventor: Anvar TUKMANOV, London (GB)

(21) Appl. No.: 18/044,438

(22) PCT Filed: Aug. 9, 2021
(86) PCT No.: PCT/EP2021/072194

§ 371 Date: Mar. 8, 2023

(30) Foreign Application Priority Data
Sep. 10, 2020 (GB) 2014268.3

(51) Int. Cl. H04W 48/18; H04W 48/16; H04L 41/5019

(52) U.S. Cl. CPC H04W 48/18; H04W 48/16; H04L 41/5019

(57) ABSTRACT

A method of configuring a network slice subnet instance on a radio access node in a wireless telecommunications network. Transceiver data identifying one or more properties of the radio access node is received. The transceiver data is processed to determine capabilities of the radio access node, wherein the capabilities indicate, for a plurality of different counts of network slice subnet instances implementable on the radio access node, a set of operating values for one or more operating parameters. Based on the determined capabilities, a count of network slice subnet instances to implement on the radio access node and the operating values for one or more operating parameters for each network slice subnet instance are selected. One or more network slice subnet instances on the radio access node are configured based on the selection. This application also relates to a computer program and a network node.

### PRIORITY CLAIM

The present application is a National Phase entry of PCT Application No. PCT/EP2021/072194, filed Aug. 9, 2021, which claims priority from GB Patent Application No. 2014268.3, filed Sep. 10, 2020, each of which is hereby fully incorporated herein by reference.

### TECHNICAL FIELD

The present disclosure relates to network slicing.

### BACKGROUND

In a telecommunications network, network slicing can be used to configure, provision and maintain logical partitions of a single physical infrastructure. Each network slice can effectively operate as a separate and independent network function (including for providing an end-to-end network service), despite using the same physical network infrastructure. This means that each network slice can be configured for a different purpose or application in a flexible and dynamic manner.

Network slices coexisting on a shared network infrastructure can be isolated from each other, so that changes in one network slice do not affect the performance of another network slice. Complete isolation of a network slice tends to be inefficient in cases in which a shared transmission medium is used. In these cases, network resources typically have to be hard-partitioned to guarantee complete isolation. However, isolation of a network slice can generally be attained in parts of a telecommunications network in which optical transport technologies are used due to the relatively high capacity of optical systems and due to the stability of optical links, which allow traffic engineering to be applied to avoid or reduce congestion.

It is desirable to perform slicing of radio resources in a radio access network (RAN), for example to realize an end-to-end network slice, e.g. in a 5G network. This is particularly desirable in RANs that utilize massive Multiple Input Multiple Output (massive MIMO) technology, so as to capitalize on the increased capability of such technology. However, network slice isolation generally cannot be assumed in radio access networks (RANs) because radio resources are scarce, and operating conditions are highly variable.

### SUMMARY

According to a first aspect of the present disclosure, there is provided a method of configuring a network slice subnet instance on a radio access node in a wireless telecommunications network, the method comprising receiving transceiver data identifying one or more properties of the radio access node; processing the transceiver data to determine capabilities of the radio access node, wherein the capabilities indicate, for a plurality of different counts of network slice subnet instances implementable on the radio access node, a set of operating values for one or more operating parameters; selecting, based on the determined capabilities, a count of network slice subnet instances to implement on the radio access node and the operating values for one or more operating parameters for each network slice subnet instance; and configuring one or more network slice subnet instances on the radio access node based on the selection.

In some examples, the set of operating values for a given count of the plurality of different counts of network slice subnet instances defines a region of operating values implementable on the radio access node for the given count. The set of operating values may correspond to a set of boundary values that coincide with a boundary of the region for the given count, and selecting the operating values may comprise selecting at least one operating value that is different from the set of boundary values for the count selected but that is within the region for the count selected.

In some examples, the one or more properties comprise one or more of: a count of transmitters of the radio access node, a count of receivers of the radio access node, a node type of the radio access node, a gain associated with the radio access node, at least one signal processing algorithm implementable by the radio access node, and a computational capability of the radio access node.

In some examples, the one or more properties comprise a usage-dependent property of the radio access node, optionally one or more of: a data rate indicative of a rate at which data is transmitted and/or received by the radio access node, and a communication range indicative of a distance over which data is transmitted and/or received by the radio access node.

In some examples, the method comprises: processing the transceiver data to determine a first operating value for a first operating parameter of the one or more operating parameters; and processing the first operating value to determine a second operating value for a second operating parameter of the one or more operating parameters.

In some examples, the one or more operating parameters comprise one or more of: a gain, a capacity, a distance over which data is transmittable and/or receivable by the radio access node, a reliability, and a latency.

In some examples, the method comprises determining, based on the determined operating values, an allocation of one or more resources of the radio access node to the one or more network slice subnet instances to be implemented on the radio access node. The one or more resources may comprise one or more of: a plurality of transmitters of the radio access node, a plurality of receivers of the radio access node, a bandwidth associated with the radio access node, and a time period for transmitting and/or receiving data by the radio access node.

In some examples, selecting the operating values comprises selecting first operating values for one or more operating parameters for a first network slice subnet instance and selecting second operating values, different from the first operating values, for the one or more operating parameters for a second network slice subnet instance.

In some examples, the radio access node is a massive Multiple Input Multiple Output, massive MIMO, node.

In some examples, selecting the operating values comprises selecting the operating values that satisfy a service level agreement (SLA).

In some examples, configuring the one or more network slice subnet instances comprises: establishing the one or more network slice subnet instances on the radio access node based on the selection; or reconfiguring the one or more network slice subnet instances on the radio access node based on the selection.

In some examples, the method comprises selecting the count of network slice subnet instances to implement on the radio access node and the operating values for one or more operating parameters for each network slice subnet instance in response to receiving a request from a user equipment, UE, for a service via a network slice subnet instance.

According to a second aspect of the present disclosure, there is provided a computer program comprising instructions which, when the program is executed by a computer, cause the computer to carry out the method of any example in accordance with the first aspect.

According to a third aspect of the present disclosure, there is provided a computer readable carrier medium comprising the computer program according to the second aspect.

According to a fourth aspect of the present disclosure, there is provided a network node for a wireless telecommunications network, the network node comprising at least one processor configured to carry out the method of any example in accordance with the first aspect.

Examples in accordance with the present disclosure may include any novel aspects described and/or illustrated herein. The disclosure also extends to methods and/or apparatus substantially as herein described and/or as illustrated with reference to the accompanying drawings. Any apparatus feature may also be provided as a corresponding step of a method, and vice versa.

Any feature in one aspect of the disclosure may be applied, in any appropriate combination, to other aspects of the disclosure. Any, some and/or all features in one aspect can be applied to any, some and/or all features in any other aspect, in any appropriate combination. Particular combinations of the various features described and defined in any aspects of the disclosure can be implemented and/or supplied and/or used independently.

As used throughout, the word or can be interpreted in the exclusive and/or inclusive sense, unless otherwise specified.

### BRIEF DESCRIPTION OF THE DRAWINGS

For a better understanding of the present disclosure, reference will now be made by way of example only to the accompany drawings, in which:

FIG. 1 is a schematic diagram showing an example of a telecommunications network.

FIG. 2 is a schematic diagram showing an example of a system for use in configuring a network slice subnet instance.

FIG. 3 is a flow diagram of an example method of establishing one or more network slice subnet instances.

FIG. 4 is a plot of nominal capacity versus gain for one network slice subnet instance.

FIG. 5 is a plot of possible capacities for two network slice subnet instances.

FIGS. 6a, 6b and 6c are plots of capacity versus gain for two network slice subnet instances implemented on a radio access node with different respective numbers of transmitters.

FIG. 7 is a flow diagram of an example method of updating a selection of network slice subnet instance(s) to establish.

FIG. 8 is a flow diagram of an example method of determining capabilities of a radio access network.

FIG. 9 is a schematic diagram showing internal components of an interpretation and control function according to an example.

FIG. 10 is a schematic diagram showing internal components of an orchestrator according to an example.

### DETAILED DESCRIPTION

Apparatus and methods in accordance with the present disclosure are described herein with reference to particular examples. The disclosure is not, however, limited to such examples.

Examples herein relate to configuration of a network slice subnet instance on a radio access node in a wireless telecommunications network. Transceiver data identifying one or more properties of the radio access network is processed to determine capabilities of the radio access node. The capabilities indicate, for a plurality of different counts of network slice subnet instances implementable on the radio access node, a set of operating values for one or more operating parameters. In other words, the capabilities indicate which operating values are possible for each of the different counts of network slice subnet instances, given the underlying infrastructure provided by the radio access node. Based on the capabilities, a count of network slice subnet instances to implement on the radio access node and the operating values for one or more operating parameters for each network slice subnet instance is selected, and one or more network slice subnet instances is configured.

This approach improves provisioning of resources and/or services in a radio access network (RAN) by incorporating properties of the radio access node of the RAN into the service setup decision process, which is often referred to as network slicing. In particular, the properties of the radio access node (such as characteristics of an antenna of the radio access node) are used to determine feasible service characteristics, including the counts of network slice subnet instances implementable by the radio access node, as well as the operating values for each of the network slice subnet instances. This allows the resources of the radio access node to be more appropriately allocated to respective network slice subnet instances, improving utilization of the radio access node. For example, where the radio access node is a massive MIMO node, a large array of transceivers (e.g. an array of tens of transceivers, such as 64 transmitters and 64 receivers, or more) can be partitioned and allocated to specific network slice subnet instances in a flexible manner. Furthermore, by accounting for the properties of the radio access node in the network slicing process, network slices that are isolated in the radio domain can be created.

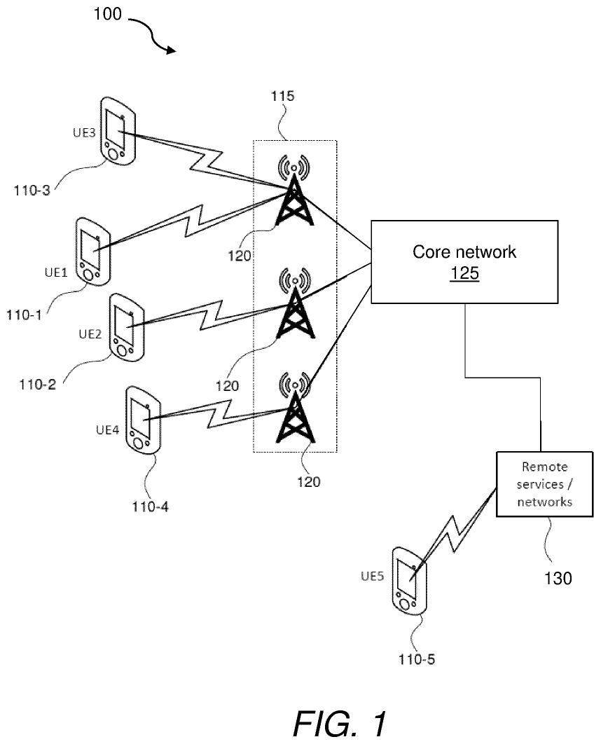

FIG. 1 shows an example of a telecommunications network 100. The network 100 is a wireless telecommunications network comprising a plurality of User Equipment (UE) 110 (e.g. in the form of a laptop, a tablet or a mobile cellular device, sometimes referred to as a smartphone). Each UE 110 is configured to utilize the network 100 by accessing a RAN 115, as provided by radio access nodes 120, which may be referred to as RAN access points (e.g. in the form of macro-, micro-, pico- or femto-cell sites). In turn, each of the radio access nodes 120 is connected to a core network 125.

The core network 125 is available to connect to remote networks and/or services, such as the Internet. As a result, the plurality of UEs 110-1 to 110-4 are also able to communicate with a UE 110-5 on a remote network 130.

As explained above, network slicing enables multiple virtual networks dedicated to different services or service types to be created using the same underlying physical infrastructure (e.g. the same radio access node 120 of the RAN 115). The virtual networks (sometimes referred to as network slices) can be isolated from each other, so that each network slice can operate independently from each other. This is typically undertaken to offer differentiated service models, which might include varying performance and/or stability characteristics within a network.

5G is envisaged to support a wide range of different use cases and services. These different services will have various different requirements, e.g. in terms of latency, throughput, connectivity and coverage. Using network slicing, which is supported by the 5G core network specifications, an appropriate virtual network can be created for each service that satisfies the requirements for that particular service. For example, there may be a network slice for smartphones, another network slice for autonomous vehicles and a further network slice for massive Internet of Things (IoT) devices.

The examples herein may be used in the configuration of a network slice within a RAN, such as the RAN 115. To configure the network slice, a network slice subnet instance is configured on a radio access node 120 of the RAN 115. A network slice subnet instance represents a portion of a network slice, which can be interconnected with other network slice subnet instances to form an end-to-end network slice. The network slice subnet instance established on the radio access node 120 may be connected to one or more other network slice subnet instances established on other radio access nodes of the RAN 120, or may instead be connected to one or more other network slice subnet instances established on the core network 125.

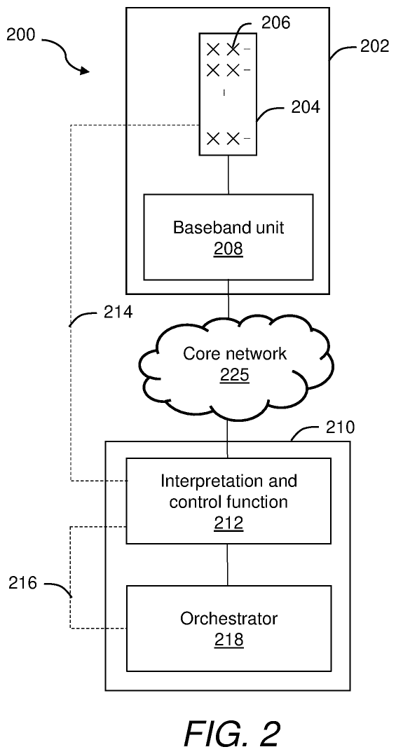

FIG. 2 is a schematic diagram showing an example of a system 200 for use in configuring a network slice subnet instance, which forms part of a wireless telecommunications network such as the network 100 of FIG. 1. The system 200 includes a radio access node 202, which includes an antenna 204 having an array of transceivers, one of which is labelled with the reference numeral 206 in FIG. 2, and which include transmitters and receivers. The radio access node 202 is a node of a RAN, such as the RAN 115 of FIG. 1, and for example corresponds to a base station of the RAN.

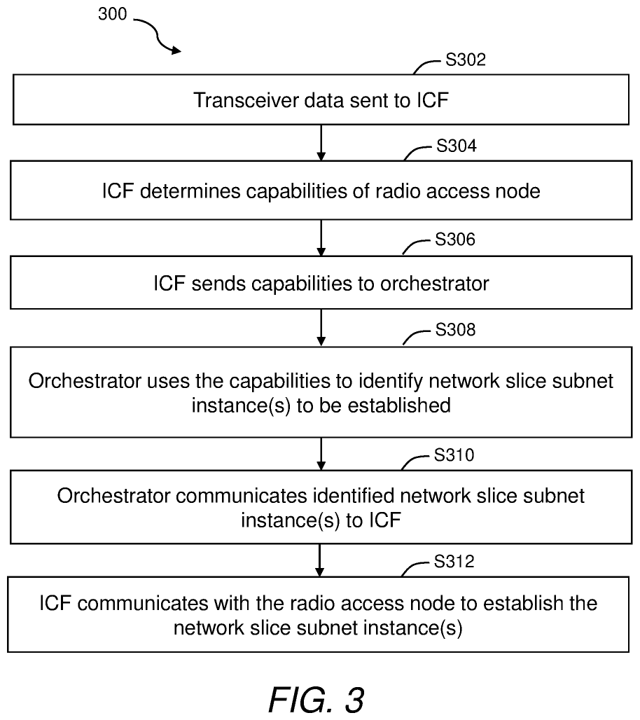

The radio access node 202 transmits and receives data from a core network 225, via a baseband unit (BBU) 208 of the radio access node 202. The core network 225 is coupled to an orchestration system 210 for orchestrating network slicing of the network, and particularly the RAN. The orchestration system 210 includes an interpretation and control function (ICF) 212, which receives transceiver data 214 identifying one or more properties of the radio access node 202 from the radio access node 202. The ICF 212 processes the transceiver data 214 to determine capabilities of the radio access node 202 (explained further with reference to FIG. 3). Capability data 216 representing the capabilities is sent from the ICF 212 to an orchestrator 218 of the orchestration system 210. The orchestrator 218 processes the capability data and generates a count of network slice subnet instances and operating values for one or more operating parameters for each network slice subnet instance, based on the capabilities. The orchestrator 218 then coordinates the configuration of the network slice subnet instance on the radio access network 202, via the ICF 212. Configuring the network slice subnet instance on the radio access network may involve establishing the network slice subnet instance on the radio access network (e.g. newly, as part of an initialization process), or reconfiguring the network slice subnet instance on the radio access network (e.g. to alter or adjust an existing configuration of the network slice subnet instance).

FIG. 3 is a flow diagram of an example method 300 of establishing one or more network slice subnet instances, which may be performed using a system such as the system 200 of FIG. 2. At S302 of the method 300, transceiver data is sent to an ICF, such as the ICF 212 of FIG. 2. The transceiver data may be sent by a component of the radio access node such as a BBU. In other cases, a different component than the radio access node sends the transceiver data. In these cases, the different component may receive the transceiver data from the radio access node (e.g. from the BBU) or from a further component of the network.

The transceiver data identifies one or more properties of the radio access node, such as one or more of:
a node type of the radio access node (e.g. whether the radio access node is a massive MIMO node),
a count of transmitters of the radio access node,
a count of receivers of the radio access node,
a gain associated with the radio access node (e.g. an antenna gain of the antenna of the radio access node),
at least one signal processing algorithm implementable by the radio access node (e.g. an algorithm that can be applied to a signal received via the radio access node and/or to a signal to be sent via the radio access node), and
a computational capability of the radio access node (such as the processing capacity of the radio access node, e.g. a count of digital signal processing cards and/or central processing units (CPUs) of the radio access node). A higher computational capability means that more complex processing can be executed by the radio access node and/or a higher number of UE can be supported.

Transceiver data of this type can facilitate an appropriate allocation of the RAN node resources to respective network slice subnet instances, e.g. where the radio access node is a massive MIMO node, which typically has a large count of transceivers, which are challenging to appropriately partition among network slice subnet instances. It is to be appreciated that, in some cases, allocation of resources of the radio access node may involve sharing at least one resource between multiple network slice subnet instances. For example, a transceiver may be allocated to, and shared by, a plurality of network slice subnet instances, e.g. each associated with a different respective user or service. In other cases, though, a resource may be exclusively allocated to a particular network slice subnet instance.

The one or more properties may instead or in addition represent operational properties of the radio access node, such as frequency band(s) supported by the radio access node, the instantaneous bandwidth (IBW) of the radio access node (e.g. corresponding to the bandwidth defined by the frequency boundaries of the frequency band(s) supported by the radio access node) and/or the operating bandwidth of the radio access node (which e.g. represents the bandwidth occupied by the radio access node during operation, defined as the sum of the active bandwidth of the frequency band(s) in operation).

In some cases, the one or more properties additionally or alternatively include a usage-dependent property of the radio access node, which is for example a property that depends on how the radio access node is being utilized, and may vary over time. In these cases, the one or more properties may include one or more of:
a data rate indicative of a rate at which data is transmitted and/or received by the radio access node. The data rate may be a peak or average rate, for example.
a communication range indicative of a distance over which data is transmitted and/or received by the radio access node (such as a distance between the radio access node and a user), which may be referred to as a range. The distance may be a maximum or average distance, for example.

A usage-dependent property may be a learned property, which may be learned based on processing of data representative of measured usage of the radio access node, e.g. during typical operation of the radio access node. For example, rate data indicative of the rate of data transmission and/or receipt, or distance data indicative of the distance of data transmission and/or receipt may be obtained, and processed to determine an average data rate or an average communication range. Any suitable processing may be applied to determine a usage-dependent property in this way, which may use machine learning or other data processing techniques.

The transceiver data may directly represent the one or more properties or may include a flag or numerical value that nevertheless indicates the one or more properties. For example, the transceiver data may use a numerical value to indicate a particular configuration of transceivers, which indicates that the radio access node includes a particular count of transmitters and receivers and is of a particular node type.

In one example, which is provided merely to aid understanding and is not intended to be limiting, three radio access nodes each send a different set of transceiver data to the ICF in accordance with S302 of FIG. 3. The sets of transceiver data are shown in the following table (referred to herein as Table 1):

| Set | Transceiver data |
|---|---|
| 1 | 8T8R (where the notation “8T8R” indicates that the radio access |
| | node includes 8 transmitters (8T) and 8 receivers (8R)) |
| 2 | 32T32R, computational capability |
| 3 | 64T64R, computational capability, instantaneous bandwidth 200 |
| | megahertz (MHz) |

Hence, in this example, all three sets of transceiver data indicate the count of transmitters and receivers. Sets 2 and 3 each additionally include the computational capability, and set 3 also includes the IBW capability of the third radio access node. The second and third radio access nodes (associated with the second and third sets of transceiver data) may be referred to as massive MIMO nodes. The IBW of the third radio access node is 200 MHz, which means that the third radio access node may support more than one channel within a 200 MHz bandwidth. This allows the third radio access node to be used for multi-operator sharing of infrastructure where multiple spectrum holdings are within the IBW provided by the third radio access node.

As sets 2 and 3 include computational capability, they provide information on the ability of the second and third radio access nodes to perform computational tasks. For example, maintenance of control information for a plurality of UE communicating with a radio access node may use computational resources. The computational capability indicated by the transceiver data may be used to identify radio access nodes (in this case the second and third radio access nodes) that are capable of supporting network slice subnet instances with more stringent computational requirements.

Referring back to FIG. 3, at S304 of the method 300, the ICF determines the capabilities of the radio access node by processing the transceiver data. The capabilities indicate, for a plurality of different counts of network slice subnet instances implementable on the radio access node, a set of operating values for one or more operating parameters. The capabilities for example indicate service characteristics such as capacity, reliability, latency and bandwidth. The capabilities hence provide conditions for a feasible allocation of the underlying resources of the radio access node to respective network slice subnet instances.

Which capabilities are determined typically depend on the transceiver data received. For example, the capabilities for the third radio access node in the example of Table 1 may include bandwidth capabilities, whereas the capabilities for the first and second radio access nodes in the example of Table 1 will generally lack bandwidth capabilities due to the lack of bandwidth information in the first and second sets of transceiver data. It is to be appreciated that the operating values themselves will vary depending on the properties of the radio access node.

As an example, for the third radio access node in Table 1, the transceiver data indicates that the antenna of the third radio access node has 64 transmitters and 64 receivers, and the third radio access node is a massive MIMO node. On this basis, it can be inferred that the third radio access node has various other properties (either based on the expected properties of a radio access node of this type or from the transceiver data itself). For example, the peak gain for a 64T64R antenna is typically 25 decibels-isotropic (dBi), which is 7 dBi more than for a typical antenna with a peak gain of 18 dBi. This means that the third radio access node can either transmit/receive signals over a larger distance or provide a higher reliability for a given distance. In other words, coverage can be traded for reliability, depending on the services to be provided. The trade-off between reliability and coverage may be determined for the third radio access node in various different ways. For example, a plot similar to that of FIG. 5 (discussed below) but of reliability versus distance rather than capacity versus gain may be obtained.

The distance over which signals can be transmitted and/or received may be an approximate distance, which can be obtained from propagation path loss models, such as the 3GPP TR38.901 models, which relate distance to a typical loss of signal power. In some cases, the distance may be determined based on analysis of performance data for subscribers using a given radio access node (the third radio access node in this example). The performance data may represent explicit or derived coordinates, which can be related to signal strength measurements that are typically available at the given radio access node.

The reliability may be indicated by a Quality of Service (QoS) Class Identifier (QCI). For instance, the QCI #69 marker effectively indicates that data is critical data, which should be dropped last in the event of congestion in the network. As an example, a particular service requirement represented by a QCI parameter, such as a packet error loss rate requirement (e.g. of less than 10-6), may be translated into a distance (or a distance boundary) for each of a plurality of different counts of network slice subnet instances implementable on the given radio access node. The conversion may be performed using a model, such as the 3GPP TR38.901 model, or via a look-up table associated with the given radio access node.

As an illustrative example, the third radio access node could support two higher reliability network slice subnet instances or could handle 3 to 4 times larger throughput for a single network slice subnet instance. In the first case, 32 transmitters and 32 receivers could be allocated to serve one network slice subnet instance with an antenna gain of approximately 22 dBi, with the remaining 32 transmitters and 32 receivers available for another network slice subnet instance. However, this is merely one possible split of resources: the available transceivers could be partitioned further and/or other resources (such as frequency and/or time domains) could be partitioned instead.

In the example of FIG. 3, the selection of which network slice subnet instances to implement is performed subsequently (discussed further below); S304 involves merely determining the capabilities that are then used to perform this selection. In the example above of the third radio access node, the capabilities are the distance over which data is transmittable and/or receivable, and the reliability. A boundary of possible distance and reliability values are determined for a plurality of different counts of network slice subnet instances, and then used to determine how many network slice subnet instances to implement using the radio access node, and which operating values to use for the network slice subnet instances (e.g. how many transceivers to allocate to each network slice subnet instance). However, this is merely an example, and other capabilities may be used in other examples.

In another example, the operating parameters indicated by the capabilities are capacity per network slice subnet instance, C, and an indication of energy and/or power available per network slice subnet instance, indicated by a gain G, which is e.g. an antenna gain. The capacity for a network slice subnet instance can be variable, e.g. taking a value from 1 up to a peak capacity M supported by the radio access network. The capacity is related to the number of transmitters or receivers of the radio access node, and, in this example, is derived from the transceiver data. In general, the capacity of the radio access node depends on the number of transmitters or receivers, but there may be other factors that influence the capacity too, such as the signal processing algorithms implementable by the radio access node. In this example, the transceiver data is processed to determine a first operating value for a first operating parameter (which in this case, is the capacity). In cases such as this, the first operating value may be processed to determine a second operating value for a second operating parameter. This is the case in this example, in which the gain is a function, ƒ, of capacity, i.e. G=ƒ(C). The skilled person would be aware of the relationship between gain and capacity, which can be derived from theory or based on particular antenna implementations.

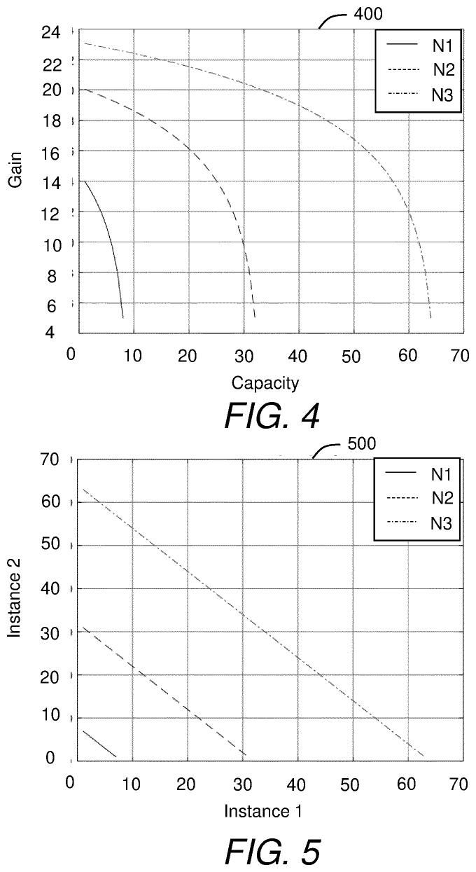

To illustrate S304 of FIG. 3 more clearly, FIGS. 4 to 6 will first be described, before returning to FIG. 3, to discuss the remaining aspects of FIG. 3.

FIG. 4 shows a plot 400 of nominal capacity versus gain for one network slice subnet instance for the first, second and third radio access nodes of the example of Table 1 (indicated on the plot 400 as “N1”, “N2” and “N3” respectively). FIG. 4 illustrates the nominal capacity versus gain. However, in practice, the actual (measured) capacity versus gain for the first, second and third radio access nodes may deviate to some extent from the nominal capacity versus gain. As can be seen, the nominal capacity for each of the radio access nodes varies from 1 up to the number of transmitters or receivers for that radio access node. Hence, for the first radio access node, the possible capacity for the network slice subnet instance is from 1 to 8 (as the first radio access node has 8 transmitters and 8 receivers).

For each line, the region of the plot 400 to the left of each line may be considered to correspond to a region of operating values (in this case, capacity and gain values) that are implementable on the radio access node corresponding to that line. Hence, the region of the plot 400 to the left of the line N1 corresponds to the region of capacity and gain values that are implementable on the first radio access node. As can be seen from FIG. 4, the massive MIMO nodes (N2 and N3) offer a wider range of possible operating values for capacity and gain than the first radio access node.

With more than one network slice subnet instance, resources of the radio access node must be shared, which leads to a large number of possible combinations of feasible resource partitioning. FIG. 5 shows a plot 500 of possible capacities for two network slice subnet instances for the first, second and third radio access nodes of the example of Table 1 (indicated on the plot 500 as “N1”, “N2” and “N3” respectively). The two network slice subnet instances are indicated on the plot 500 as “Instance 1” and “Instance 2”. In this case, both network slice subnet instances can be allocated one unit of capacity or each, or any other combination lying to the left of the lines on the plot 500. In other words, the region of the plot 500 to the left of the line N1 corresponds to the capacities that are implementable on the first radio access node for two network slice subnet instances. The capabilities for two network slice subnet instances may indicate the set of operating values for the capacities (e.g. the line shown in FIG. 5 for a given radio access node). In this case, the capabilities indicate the possible split in capacity between the two network slice subnet instances.

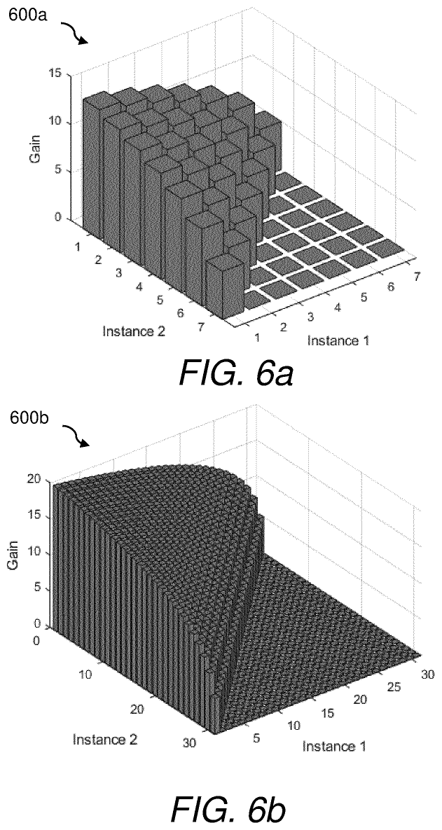

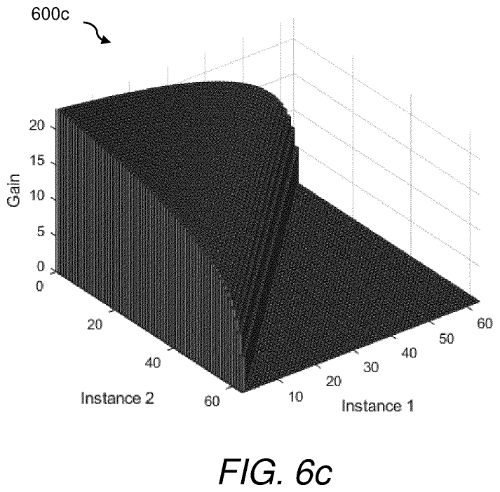

In other cases, though, the capabilities may indicate a set of operating values for at least one parameter in addition to the capacity. Each feasible combination of capacity allocation between the two network slice subnet instances implies a corresponding partitioning in the energy associated with each network slice subnet instance. For example, when each network slice subnet instance is allocated one unit of capacity, each network slice subnet instance can also be allocated individual gains, up to a maximum value that depends on the radio access node used to implement the network slice subnet instances. FIGS. 6a to 6c indicate plots 600a to 600c of possible gain and capacity allocations for two network slice subnet instances. The plot 600a of FIG. 6a indicates the possible operating values for the gain (on the vertical axis) for 7 capacity values for two network slice subnet instances (“Instance 1” and “Instance 2”) for the first radio access node, which has 8 transmitters and 8 receivers. The plots 600b, 600c of FIGS. 6b and 6c are the same as FIG. 6a, but for the second and third radio access nodes, respectively, instead of the first radio access node.

Referring to FIG. 6a as an illustrative example, the Instance 1 capacity point 1 and Instance 2 capacity point 7 has a gain of 5 dBi, which means that both network slice subnet instances (Instances 1 and 2) would be allocated a gain of 5 dBi in total, to be divided between the capacity units allocated to Instances 1 and 2. This means that Instance 2 has a lower energy (i.e. lower gain) per capacity unit than Instance 1. In this case, Instance 2 hence has a lower reliability capability than Instance 1. A determination of capacity versus gain may hence be used to determine a reliability capability for different counts of respective network slice subnet instances.

In the examples of FIGS. 4 to 6, the set of operating values (the capacity and/or gain values) for a given count of the plurality of different counts of network slice subnet instances defines a region of operating values implementable on the radio access node for the given count. In other words, the set of operating values for a given count represents a boundary of possible operating values that can be implemented on the radio access node. In this case, the set of operating values for each of the counts that are implementable corresponds to a set of boundary values that coincide with a boundary of the region, i.e. a boundary of viable combinations of network slice subnet instances implementable on the radio access node. Hence, rather than determining an exhaustive set of all possible network slice subnet instance combinations, in this case a boundary representing a viable performance (as indicated by the set of operating values) can be determined instead. Any combination of network slice subnet instances that do not exceed the boundary (i.e. that have operating values that are within the region of operating values defined by the set of operating values) can be assigned to the radio access node. This reduces computational overheads compared to determining an exhaustive set of possible network slice subnet instance combinations. This means that, in some cases, the operating values selected are different from the set of boundary values (and hence different from the set of operating values indicated by the capabilities) but nevertheless lie within the region of operating values bounded by the set of boundary values.

In examples herein, the capabilities for a given radio access node are determined for each of a plurality of different counts of network slice subnet instances. For example, the gain and capacity capabilities may be determined for a single network slice subnet instance as described with reference to FIG. 4, for two network slice subnet instances as described with reference to FIGS. 6a to 6c, and in some cases for at least one further count of network slice subnet instances (e.g. 3, 4 or more). In some cases, the same capabilities are determined for each of the plurality of different counts, although this need not be the case in other examples. For example, the gain and capacity capabilities may be determined for a single network slice subnet instance as described with reference to FIG. 4, but solely the capacity capabilities may be determined for two network slice subnet instances.

In other cases, at least one other capability may be determined instead of or in addition to the gain and/or capacity. In one example, the capability determined using the transceiver data indicates or relates to the bandwidth supported by a radio access node for each of a plurality of different counts of network slice subnet instances. In this case, the transceiver data indicates the IBW of the radio access node, which provides a measure of how far apart in frequency space transmitted or received signals can be. The IBW is useful in the context of RAN slicing because a large IBW indicate that a radio access node can transmit and receive multiple spectrum holdings belonging to one or more telecommunications operators. For example, if two operators have a spectrum of X MHz and Y MHz available, respectively, and the radio access node is capable of transmitting in a bandwidth of Z MHz bandwidth, where Z≥X+Y, then the radio access node can support resource isolation in the frequency domain.

The transceiver data in this example is processed to determine capabilities indicating the number and/or width of channels the radio access node can support, for each of a plurality of different counts of network slice subnet instances. The capacity and reliability capabilities of the radio access node typically depend on the number and/or width of channels supported by the radio access node since power is generally limited per node. In other words, the total power may be divided between a plurality of network slice subnet instances utilizing a plurality of channels. Hence, in other cases, the capabilities may indicate the capacity and/or reliability instead of the number and/or width of channels (although typically these capabilities depend on each other).

Referring back to FIG. 3, at S306 of the method 300, the capabilities are sent from the ICF to an orchestrator, such as the orchestrator 218 of FIG. 2.

At S308 of the method 300, the orchestrator uses the capabilities to identify network slice subnet instance(s) to be established. This for example involves the orchestrator selecting, based on the capabilities, a count of network slice subnet instances to implement, and the operating values for one or more operating parameters (e.g. gain and capacity values for each network slice subnet instance to be implemented). The selection may be made solely based on the capabilities or based on the capabilities and further data, e.g. indicative of a requested service by a user of the radio access node. In some cases, the operating values that satisfy a service level agreement (SLA) are selected. A SLA for example defines the level of service provided by a telecommunications operator. The telecommunications operator may hence request the creation of a network slice that satisfies a SLA, so as to provide a service that complies with the SLA to customers.

In this example, the operating values are converted into a policy for operation of the radio access node. For example, an allocation of one or more resources of the radio access node (such as the transmitters and/or receivers) to the one or more network slice subnet instances may be determined based on the operating values. In some cases, allocating the one or more resources involves partitioning or otherwise dividing the resources of the radio access node between two or more network slice subnet instances. Various resources of the radio access node may be allocated in this manner, such as one or more of:
The transmitters of the radio access node.
The receivers of the radio access node.
A bandwidth associated with the radio access node. For example, the frequency domain supported by the radio access node may be divided into a plurality of frequency bands, each associated with a different respective network slice subnet instance to be implemented using the radio access node.
A time period for transmitting and/or receiving data by the radio access node. In other words, different respective sets of time slots may be allocated to different respective network slice subnet instances.

In one illustrative example, the orchestrator selects two network slice subnet instances to implement using the third radio access node, based on the capabilities (which in this case define a region of operating values of gain and capacity for each of a plurality of different counts of network slice subnet instances, as shown in FIG. 4 and FIG. 6c for one and two network slice subnet instances). A particular gain and capacity value allocated to each of the network slice subnet instances is determined from the capabilities, which lie within the region of operating values. The gain and capacity values are converted to resource allocations for the two network slice subnet instances. In this case, 32 transmitters and receivers are allocated to a first network slice subnet instance, with a first gain, and the remaining 32 transmitters and receivers are allocated to a second network slice subnet instance, with a second gain (which may be the same as or different from the first gain).

In a further illustrative example, two network slice subnet instances (Instance 1 and Instance 2) are selected for establishment on a radio access node, with respective operating values of capacity point 1 for Instance 1 and capacity point 7 for Instance 2. In this example (for which the capabilities may be as shown in FIG. 6a), Instance 1 is used by one user for mission-critical traffic (indicated by the QCI #69 marker), and Instance 2 is used by 7 users of a video streaming service. The radio access node has a particular coverage area, within which service to Instance 1 is guaranteed by deriving site-specific operation boundaries. Allocation of the resources at the radio access node to maintain the service level agreements for the two network slice subnet instances may then be performed by monitoring connection parameters such as the packet error rate. As the radio access node properties were taken into account during establishment of the network slice subnet instances, the service level agreements should be complied with during operation of the radio access node.

In examples in which the set of operating values indicated by the capabilities define a region of operating values implementable on a radio access node for a particular count of network slice subnet instances, it is to be appreciated that at least one operating value selected for implementation of that count of network slice subnet instances may differ from the operating values within the set of operating values. However, the selected operating values in this case are nevertheless within the region of operating values implementable on the radio access node for the count selected, so that the radio access node is capable of supporting the selected operating values.

The operating values selected may differ between different network slice subnet instances. For example, first operating values may be selected for one or more operating parameters for a first network slice subnet instance and second operating values, different from the first operating values, may be selected for the one or more operating parameters for the second network slice subnet instance. This provides additional flexibility and improves the utilization of the resources of the radio access network. For example, if the first network slice subnet instance has less stringent requirements, e.g. in terms of reliability, than the second network slice subnet instance, it can be allocated fewer resources than the second network slice subnet instance. This can improve utilization of the resources of the radio access network, and reduce under- or over-utilization of the radio access network.

At S310 of FIG. 3, the orchestrator communicates the identified network slice subnet instance(s) and the resource allocations to the ICF. At S312 of FIG. 3, the ICF communicates with the radio access node to establish the network slice subnet instance(s) with the determined resource allocations.

The method 300 of FIG. 3 is described in the context of establishing one or more network slice subnet instances using a radio access node. However, it is to be appreciated that a similar approach may be used to map network slice subnet instances to different respective radio access nodes of a RAN in a manner that exploits the individual performance capabilities of individual radio access nodes. In this way, methods such as that of FIG. 3 can be used to determine the number of network slice subnet instances to establish on respective radio access nodes of RAN.

The method 300 of FIG. 3, or other methods of establishing one or more network slice subnet instances according to examples herein, may be performed during initial provisioning of the radio access node (e.g. before the radio access node is first put into operation). In other cases, though, one or more network slice subnet instances may be established or reconfigured during operation of the radio access node, in an otherwise similar manner. In this way, the count of network slice subnet instances established using the radio access node can vary over time, e.g. depending on the requirements of users of the radio access node, such as the UE and/or a telecommunications operator associated with particular UE, or to account for a change in one or more properties of the radio access node.

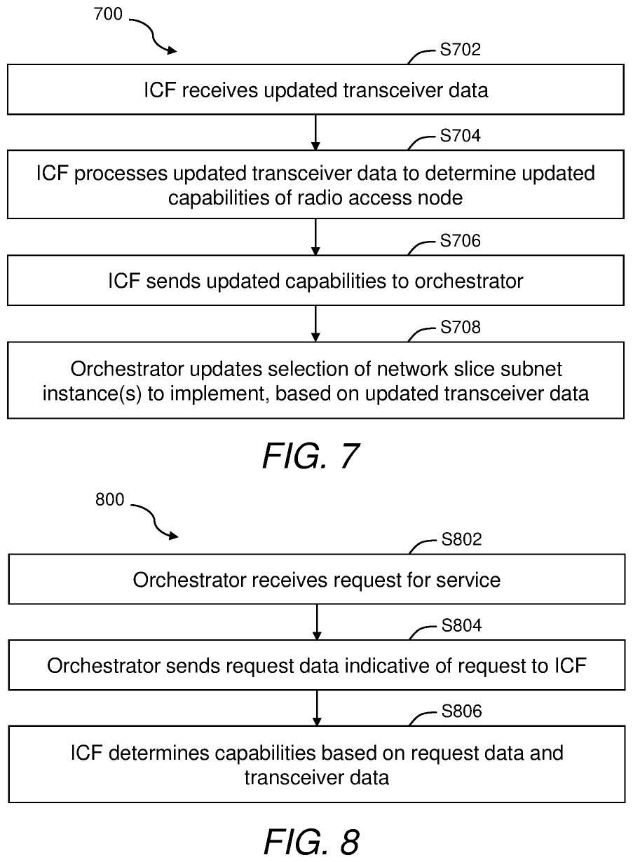

FIG. 7 is a flow diagram of an example method 700 of updating a selection of network slice subnet instance(s) to establish. The method 700 of FIG. 7 may for example be performed after the method 300 of FIG. 3, e.g. using the same components as those used to implement the method 300 of FIG. 3, and may use a system similar to or the same as the system 200 of FIG. 2. At S702, an ICF (e.g. the ICF 212 of FIG. 2) receives updated transceiver data. The updated transceiver data may be otherwise similar to the transceiver data described with reference to FIG. 2, and may represent the same or similar properties of the radio access node. However, in this case, the updated transceiver data indicates a change in at least one of the one or more properties of the radio access node. For example, the updated transceiver data may indicate a change in a usage-dependent property of the radio access node, such as a change in a data rate or a communication distance of the radio access node.

At S704, the ICF processes the updated transceiver data to determine updated capabilities of the radio access node. The updated capabilities indicate, for the plurality of different counts of network slice subnet instances implementable on the radio access node, an updated set of operating values for the one or more operating parameters. S704 may be similar to step S304 of FIG. 3, but based on processing of the updated transceiver data rather than the transceiver data.

At S706, the ICF sends the updated capabilities to an orchestrator (e.g. the orchestrator 218 of FIG. 2). At S708, the orchestrator updates the selection of the count of network slice subnet instances to implement and/or the operating values of the one or more parameters of the count of the network slice subnet instances. The selection is updated based on the updated transceiver data. For example, the updated selection may be determined in a similar manner to the determination of the selection at S308 of FIG. 3. The orchestrator may then identify one or more network slice subnet instances to be established or reconfigured, based on the updated selection, as well as the resources to allocate to each network slice subnet instance, as described further with reference to FIG. 3. The establishment or reconfiguration of the updated network slice subnet instance(s) may then be performed, e.g. as described with reference to S310 and S312 of FIG. 3.

In the example of FIG. 3, the method 300 involves determining the capabilities of the radio access node based on the transceiver data. In other cases, the capabilities of the radio access node are determined based on the transceiver data and other data. FIG. 8 is a flow diagram of such an example method 800. The method 800 of FIG. 8 may be performed using a system similar to or the same as the system 200 of FIG. 2.

At S802 of FIG. 8, an orchestrator (e.g. the orchestrator 218 of FIG. 2) receives a request for a service via network slice subnet instance. The request is sent from a requesting party, e.g. to request the creation of a network slice to support the service. The requesting party may be a telecommunications operator or other party, and may be sent from a UE.

At S804, the orchestrator sends request data indicative of the request to an ICF (e.g. the ICF 212 of FIG. 2). The request data may indicate various constraints that must be satisfied by a network slice subnet instance established. For example, the request data may indicate a particular service level desired by the requesting party (such as a SLA that a requesting party intends to offer customers, as discussed above with reference to FIG. 3). In other cases, the request data may merely indicate that the creation of a network slice subnet instance is request, without providing further information regarding the nature of the network slice subnet instance. For example, in some cases, the request data may indicate a request that resources are guaranteed, e.g. to satisfy a SLA, whereas this need not be the case in other examples.

At S806, the ICF determines the capabilities of the radio access node, e.g. as explained with reference to S304 of FIG. 3, based on the request data and the transceiver data. In such cases, the request data may constrain the capabilities of the radio access node further. For example, the request data may indicate a requirement that a particular capability (e.g. a gain, capacity, etc.) meets or exceeds a particular condition. This may reduce the region of possible operating values that are implementable by the radio access node to those that also satisfy constraints indicated by the request data.

The capabilities determined by the ICF at S806 of FIG. 8 may then be sent to the orchestrator, e.g. as described with reference to S306 of FIG. 3, and one or more network slice subnet instances may then be established, e.g. as described with reference to S308 to S312 of FIG. 3.

FIG. 8 is an example in which the count of network slice subnet instances to implement on a radio access node is selected in response to receiving a request for a service via a network slice subnet instance. In this way, a network slice subnet instance can be newly-established when a new request is received. Network slicing of a RAN can therefore be flexibly performed, to optimize usage of the underlying resources appropriately depending on the service(s) the RAN is to provide (which may change over time).

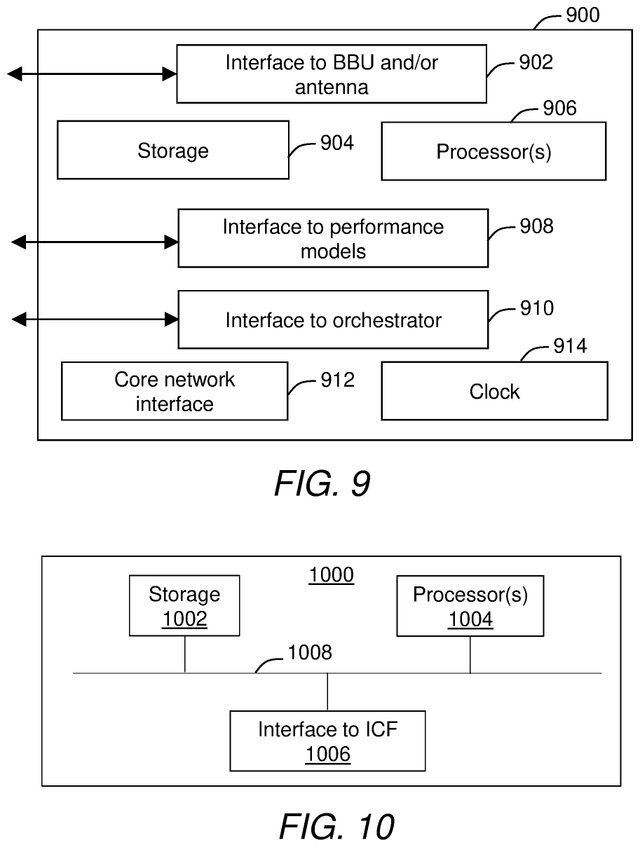

FIG. 9 is a schematic diagram showing internal components of an ICF 900 according to an example. The ICF 900 includes an interface 902 to a BBU and/or antenna, such as the BBU 208 and/or antenna 204 of FIG. 2. Transceiver data is received at the ICF 900 in this example via the interface 902.

The ICF 900 includes storage 904 for storing the transceiver data. The storage 904 may be or include volatile or non-volatile memory, read-only memory (ROM), or random access memory (RAM). The storage 904 may additionally or alternatively include a storage device, which may be removable from or integrated within the ICF 900. The storage 904 may be referred to as memory, which is to be understood to refer to a single memory or multiple memories operably connected to one another. The storage 904 may also store capability data indicative of the capabilities determined by processing the transceiver data.

The storage 904 may be or include a non-transitory computer-readable medium. A non-transitory computer-readable storage medium includes, but is not limited to, volatile memory, non-volatile memory, magnetic and optical storage devices such as disk drives, magnetic tape, compact discs (CDs), digital versatile discs (DVDs), or other media that are capable of storing code and/or data.

At least one processor 906 is communicatively coupled to the storage 904, and is arranged to process the transceiver data to determine the capabilities of the radio access node, e.g. as explained further with reference to FIGS. 3 to 8. The at least one processor 906 may be or comprise processor circuitry. The at least one processor 906 is arranged to execute program instructions and process data. The at least one processor 906 may include a plurality of processing units operably connected to one another, including but not limited to a central processing unit (CPU) and/or a graphics processing unit (GPU).

The ICF 900 of FIG. 9 includes an interface 908 to performance models, which are e.g. indicative of performance of the radio access node. The performance models may for example be used to obtain a usage-dependent property of the radio access node, which may be a learned property of the radio access node. The performance models (or data obtained therefrom) may be implemented using a remote computer system. Hence, the interface 908 to the performance models may be an interface to a remove computer system.

The ICF 900 of FIG. 9 also includes an interface 910 to an orchestrator, such as the orchestrator 218 of FIG. 2. The ICF 900 can use the interface 910 to the orchestrator to send the capabilities to the orchestrator (e.g. in the form of capability data) and/or to receive, from the orchestrator, an indication of network slice subnet instance(s) to establish, along with data indicative of a configuration of the radio access node to establish the network slice subnet instance(s).

The ICF 900 has a core network interface 912 to communicate with a core network, such as the core network 125, 225 of FIGS. 1 and 2, and a clock 914. The ICF 900 may have additional components not shown in FIG. 9, such as a bus for communicating data between respective components. In other cases, ICFs that are otherwise similar to the ICF 900 of FIG. 9 may lack at least one component of FIG. 9.

FIG. 10 is a schematic diagram of internal components of an orchestrator 1000 that may be used in any of the methods described herein, such as the orchestrator 218 of FIG. 2. The orchestrator 1000 may include additional components not shown in FIG. 10; only those most relevant to the present disclosure are shown. The orchestrator 1000 includes storage 1002, which may be similar to the storage 904 of the ICF 900 of FIG. 9, but arranged to store capabilities received from an ICF and, in some cases, data indicative of a count of network slice subnet instances to implement on the radio access node, the operating values for one or more operating parameters for each network slice subnet instance and/or an allocation of resources of the radio access node to respective ones of the count of network slice subnet instances.

The orchestrator 1000 also includes at least one processor 1004 which is configured to implement the methods described herein to select a count of network slice subnet instances to implement on the radio access node and the operating values for one or more operating parameters for each network slice subnet instance, and, in some cases, to allocate resources of the radio access node to respective ones of the count of network slice subnet instances, based on the selection.

The orchestrator 1000 further includes an interface 1006 to the ICF, to communicate with the ICF. The orchestrator 1000 may include at least one further interface (not shown in FIG. 10) for connecting to at least one further component. The components of the orchestrator 1000 are communicably coupled via a suitable bus 1008.

An ICF and an orchestrator such as the ICFs 212, 900 of FIGS. 2 and 9 and the orchestrators 218, 1000 of FIGS. 2 and 10 may be considered to correspond to an orchestration system. In some cases, the functionality of an ICF and an orchestrator as described in examples herein may be integrated in a single component (which may or may not be a distributed system), or a different system may be used to provide this functionality.

### Alternatives and Modifications

Further examples are envisaged. In examples above, the radio access node includes transceivers including both transmitters and receivers. It is to be appreciated that the concepts described herein may also be used with radio access nodes with solely transmitters or solely receivers.

FIG. 3 shows an example method 300 for establishing a network slice subnet instance on a radio access node. However, a similar method may be used to reconfigure a network slice subnet instance that has already been established on a radio access node, e.g. in a manner similar to that described with reference to FIG. 7. For example, the transceiver data sent to the ICF in S302 of FIG. 3 may correspond to the updated transceiver data described with reference to S702 of FIG. 7. Similarly, the capabilities referred to with reference to FIG. 3 may be updated capabilities as described with reference to FIG. 7.

Various examples of transceiver data are described above. However, these are merely examples. Other properties of a radio access node that may be represented by the transceiver data may additionally or alternatively be one or more of: a cell identifier (ID) associated with the radio access node, a sector ID associated with the radio access node, bearer activity associated with the radio access node, and a channel feedback report associated with the radio access node.

The examples above provide various examples of capabilities. It is to be appreciated that various other capabilities or combinations of capabilities may be used in other examples. For example, the one or more operating parameters indicated by the capabilities may include one or more of: a gain, a capacity, a distance over which data is transmittable and/or receivable by the radio access node, a reliability, and a latency.

In FIG. 3, the set of operating values determined using the transceiver data define a region of operating values. In other cases, though, the set of operating values may represent all of the operating values that are implementable on the radio access node for a given count of network slice subnet instances, rather than corresponding to a boundary of a region of a possible operating values. This is more computationally intensive, but may be appropriate in some cases (e.g. where the number of combinations of possible network slice subnet instances is relatively small).

In FIG. 3, the orchestrator communicates the identified network slice subnet instance(s) to the ICF, and the ICF communicates with the radio access node to establish the network slice subnet instance(s). However, in other examples, the orchestrator may instead send a control message to the radio access node to establish the network slice subnet instance(s) with the determined resource allocations. As an illustrative example, the control message may indicate that the radio access node should accept solely one service using a first network slice subnet instance and up to seven users of a second network slice subnet instances. If the radio access node receives a request that would exceed one of these bounds, the control message in this example configures the radio access node to request further instructions from the orchestrator. Hence, the ICF need not be involved in establishing the network slice subnet instance(s) (once the count of network slice subnet instance(s) and the operating values of the one or more operating parameters has been selected).

Further examples relate to a computer program comprising instructions which, when the program is executed by a computer, cause the computer to carry out any of the methods described herein. Such a computer program may comprised by a computer readable carrier medium.

Yet further examples relate to a network node (e.g. comprising or forming part of an orchestration system) for a wireless telecommunications network, the network node comprising at least one processor configured to carry out the steps of any of the methods described herein. Such a network node may for example comprise a component to implement the functionality of an ICF and a further component to implement the functionality of an orchestrator as described in the examples herein.

Each feature disclosed herein, and (where appropriate) as part of the claims and drawings may be provided independently or in any appropriate combination.

Any reference numerals appearing in the claims are for illustration only and shall not limit the scope of the claims.

In general, it is noted herein that while the above describes examples, there are several variations and modifications which may be made to the described examples without departing from the scope of the appended claims. One skilled in the art will recognize modifications to the described examples.

1. A method of configuring a network slice subnet instance on a radio access node in a wireless telecommunications network, the method comprising:
receiving transceiver data identifying one or more properties of the radio access node;
processing the transceiver data to determine capabilities of the radio access node, wherein the capabilities indicate, for a plurality of different counts of network slice subnet instances implementable on the radio access node, a set of operating values for one or more operating parameters;
selecting, based on the determined capabilities, a count of network slice subnet instances to implement on the radio access node and the operating values for one or more operating parameters for each network slice subnet instance; and
configuring one or more network slice subnet instances on the radio access node based on the selection.

2. The method according to claim 1, wherein the set of operating values for a given count of the plurality of different counts of network slice subnet instances defines a region of operating values implementable on the radio access node for the given count.

3. The method according to claim 2, wherein the set of operating values corresponds to a set of boundary values that coincide with a boundary of the region for the given count, and selecting the operating values comprises selecting at least one operating value that is different from the set of boundary values for the count selected but that is within the region for the count selected.

4. The method according to claim 1, wherein the one or more properties comprise one or more of:
a count of transmitters of the radio access node,
a count of receivers of the radio access node,
a node type of the radio access node,
a gain associated with the radio access node,
at least one signal processing algorithm implementable by the radio access node, and
a computational capability of the radio access node.

5. The method according to claim 1, wherein the one or more properties comprise a usage-dependent property of the radio access node.

6. The method according to claim 1, comprising:
processing the transceiver data to determine a first operating value for a first operating parameter of the one or more operating parameters; and
processing the first operating value to determine a second operating value for a second operating parameter of the one or more operating parameters.

7. The method according to claim 1, wherein the one or more operating parameters comprise one or more of:
a gain,
a capacity,
a distance over which data is transmittable or receivable by the radio access node,
a reliability, and
a latency.

8. The method according to claim 1, comprising determining, based on the determined operating values, an allocation of one or more resources of the radio access node to the one or more network slice subnet instances to be implemented on the radio access node.

9. The method according to claim 8, wherein the one or more resources comprise one or more of:
a plurality of transmitters of the radio access node,
a plurality of receivers of the radio access node,
a bandwidth associated with the radio access node, and
a time period for transmitting or receiving data by the radio access node.

10. The method according to claim 1, wherein selecting the operating values comprises selecting first operating values for one or more operating parameters for a first network slice subnet instance and selecting second operating values, different from the first operating values, for the one or more operating parameters for a second network slice subnet instance.

11. The method according to claim 1, wherein the radio access node is a massive Multiple Input Multiple Output (massive MIMO) node.

12. The method according to claim 1, wherein selecting the operating values comprises selecting the operating values that satisfy a service level agreement (SLA).

13. The method according to claim 1, wherein configuring the one or more network slice subnet instances comprises:
establishing the one or more network slice subnet instances on the radio access node based on the selection; or
reconfiguring the one or more network slice subnet instances on the radio access node based on the selection.

14. The method according to claim 1, comprising selecting the count of network slice subnet instances to implement on the radio access node and the operating values for one or more operating parameters for each network slice subnet instance in response to receiving a request from a user equipment (UE) for a service via a network slice subnet instance.

15. A non-transitory computer-readable storage medium storing a computer program comprising instructions which, when the computer program is executed by a computer, cause the computer to carry out the method of claim 1.

16. A system comprising:
at least one processor and memory to configure a network slice subnet instance on a radio access node in a wireless telecommunications network by:
receiving transceiver data identifying one or more properties of the radio access node;
processing the transceiver data to determine capabilities of the radio access node, wherein the capabilities indicate, for a plurality of different counts of network slice subnet instances implementable on the radio access node, a set of operating values for one or more operating parameters;
selecting, based on the determined capabilities, a count of network slice subnet instances to implement on the radio access node and the operating values for one or more operating parameters for each network slice subnet instance; and
configuring one or more network slice subnet instances on the radio access node based on the selection.

17. A network node for a wireless telecommunications network, the network node comprising at least one processor to configure a network slice subnet instance on a radio access node in a wireless telecommunications network by:
receiving transceiver data identifying one or more properties of the radio access node;
processing the transceiver data to determine capabilities of the radio access node, wherein the capabilities indicate, for a plurality of different counts of network slice subnet instances implementable on the radio access node, a set of operating values for one or more operating Parameters;
selecting, based on the determined capabilities, a count of network slice subnet instances to implement on the radio access node and the operating values for one or more operating parameters for each network slice subnet instance; and
configuring one or more network slice subnet instances on the radio access node based on the selection.

18. The method according to claim 5, wherein the one or more properties comprise one or more of:
a data rate indicative of a rate at which data is transmitted or received by the radio access node, and
a communication range indicative of a distance over which data is transmitted or received by the radio access node.
